(19) United States
(12) Patent Application Publication
(10) Pub. No.: US 2013/0004126 A1
(43) Pub. Date: Jan. 3, 2013

(54) PREFABRICATED DISTRIBUTION OPTICAL CABLE AND METHOD FOR FABRICATING THE SAME

(75) Inventors: Wenxin WU, Shenzhen (CN); Bo WANG, Wuhan (CN); Jichang DENG, Shenzhen (CN); Jianmin LIU, Mexico City (MX)

(73) Assignee: Huawei Technologies Co., Ltd., Shenzhen (CN)

(21) Appl. No.: 13/608,810

(22) Filed: Sep. 10, 2012

Related U.S. Application Data
(63) Continuation of application No. PCT/CN2011/079790, filed on Sep. 17, 2011.

(30) Foreign Application Priority Data
Oct. 22, 2010 (CN) 201010530400.5

(51) Int. Cl. G02B 6/36; B23P 11/00

(52) U.S. Cl. 385/77; 29/428

(57) ABSTRACT

A prefabricated distribution optical cable includes a distribution optical cable, that includes at least one optical cable subunit, where the number of fibers of each optical cable subunit is equal to the number of fibers needing to branch off; a branch optical cable, being an optical cable subunit of a specific length branching off from the distribution optical cable; a branch protecting unit, configured to fasten a branch point of the distribution optical cable and the branch optical cable and provide sealing protection for the branch point; and a connector unit, configured to terminate the branch optical cable.

### CROSS-REFERENCE TO RELATED APPLICATIONS

This application is a continuation of International Application No. PCT/CN2011/079790, filed on Sep. 17, 2011, which claims priority to Chinese Patent Application No. 201010530400.5, filed on Oct. 22, 2010, both of which are hereby incorporated by reference in their entireties.

### FIELD OF THE APPLICATION

The present application relates to the field of fiber communication technologies, and in particular, to a prefabricated distribution optical cable, and a method for fabricating the same.

### BACKGROUND OF THE APPLICATION

Currently, when implementing splicing of a distribution optical cable straight or branching of a distribution optical cable, an optical cable division box or a connecting box is generally used. At a user access point, an optical cable is led into the box and fastened. In the box, the distribution optical cable is spliced with a distribution optical cable that needs to be connected with a drop cable on the site, and the remaining fibers of the distribution optical cable extend to the next branch point or access point. An optical cable division box or connecting box is usually big in size, and needs to be mounted in a specific place. Moreover, the optical cable needs to be spliced on the site in the construction process, the spliced fiber needs to be spooled and sealed, and the box needs to be installed, which makes maintenance and expansion rather inconvenient.

As shown in FIG. 1, to reduce work inconvenience caused by the use of the optical cable division box or connecting box on the site, the prior art provides a solution to branching off a pre-connected distribution optical cable. In the solution, the distribution optical cable at the branch point is wrapped with a flexible sleeve to form an “optical cable cavity” like micro connecting box in the process of prefabricating the branch fiber in the factory; in the cavity, a part of fibers in the optical cable subunit in the distribution optical cable are cut off, and undergo multi-fiber splicing and protection with the tail cable; meanwhile, the fibers that require splicing straight in the distribution optical cable go on being spliced straight, thereby implementing the branching function and the straight splicing function in the cavity.

In the implementation of the disclosed embodiments, the inventor finds that in the solution to branch a pre-connected distribution optical cable in the prior art, when a part of fibers in the optical cable subunit in the distribution optical cable are cut off and spliced, other fibers in the same optical cable subunit go on being spliced straight, which tends to damage the straight-through fibers.

### SUMMARY OF THE APPLICATION

Embodiments provide a prefabricated distribution optical cable and a method for fabricating the same, so as to avoid damage to the straight-through fibers in the process of prefabricating the branch fibers in the factory.

The embodiments adopt the following technical solutions:

A prefabricated distribution optical cable includes:

a distribution optical cable, including at least one optical cable subunit, where the optical cable subunit includes the number of fibers of each optical cable subunit is equal to the number of fibers needing to branch off;

a branch optical cable, being an optical cable subunit of a specific length branching off from the distribution optical cable;

a branch protecting unit, configured to fasten a branch point of the distribution optical cable and the branch optical cable and provide sealing protection for the branch point; and
a connector unit, configured to terminate the branch optical cable, where the number of fibers of the terminated cable is equal to the number of fibers in the branch optical cable.

A method for fabricating the foregoing prefabricated distribution optical cable includes:

cutting off an optical cable subunit needing to branch off, where the number of fibers in the optical cable subunit is equal to the number of fibers needing to branch off;

stripping a section of an outer protection layer off the distribution optical cable at a branch point and extracting the cut optical cable subunit;

fastening the branch point and provide sealing protection for the branch point; and

terminating the extracted optical cable subunit, where the number of fibers of the terminated cable is equal to the number of fibers in the branch optical cable.

Further, a prefabricated distribution optical cable includes a distribution optical cable and a connector unit, the distribution optical cable includes a plurality of optical cable subunits, wherein the number of fibers of each optical cable subunit is equal to the number of fibers needing to branch off, and wherein one of the optical cable subunits branches from the distribution optical cable to be a branch optical cable; the connector unit is configured to terminate the branch optical cable, wherein the number of fibers of the terminated cable is equal to the number of fibers in the branch optical cable.

As revealed in the foregoing technical solutions, the prefabricated distribution optical cable is fabricated by wrapping an optical cable subunit in the distribution optical cable, and the number of fibers of the wrapped optical cable subunit is equal to the number of fibers needing to branch off at each branch point. In this way, when prefabricating the branch fibers in the factory, the corresponding optical cable subunit can branch off directly, and other optical cable subunits keeps straight-through. Therefore, the branching optical cable subunit is independent of the straight-through optical cable subunit in the distribution optical cable, thereby avoiding damage to the straight-through fibers in the process of prefabricating the branch fibers in the factory.

### BRIEF DESCRIPTION OF THE DRAWINGS

To make the technical solutions of the embodiments clearer, the accompanying drawings used in description of the embodiments are illustrated in brief below.

FIG. 1 is a schematic diagram of a method of branching a pre-connected distribution optical cable in the prior art;

FIG. 2 is a schematic structural diagram of a prefabricated distribution optical cable according to an embodiment;

FIG. 3 is a structural diagram of a branch protecting unit according to an embodiment;

FIG. 4 is an overall structural diagram of a prefabricated distribution optical cable according to an embodiment;

FIG. 5 is a schematic structural diagram of a branch optical cable according to an embodiment;

FIG. 6 is a schematic flowchart of a method for fabricating a prefabricated distribution optical cable according to an embodiment; and

FIG. 7 is an application scenario of connecting a prefabricated distribution optical cable with a drop cable according to an embodiment.

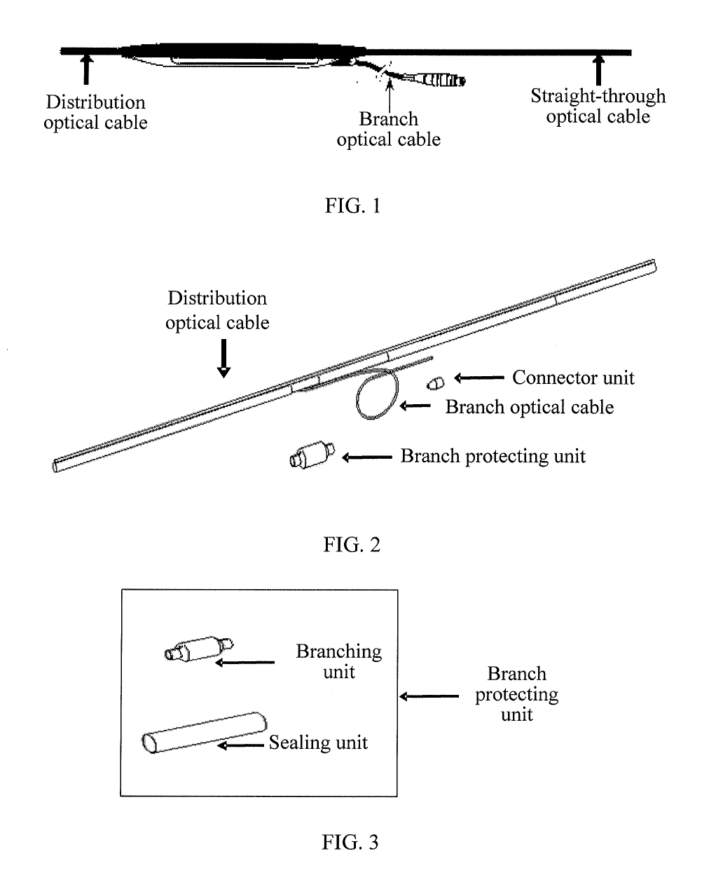

### DETAILED DESCRIPTION OF THE EMBODIMENTS

The technical solutions are described clearly and completely below with reference to the accompanying drawings.

As shown in FIG. 2, an embodiment provides a prefabricated distribution optical cable, including:

a distribution optical cable, including at least one optical cable subunit, where the number of fibers of each optical cable subunit is equal to the number of fibers needing to branch off;

a branch optical cable, being an optical cable subunit of a specific length branching off from the distribution optical cable;

a branch protecting unit, configured to fasten a branch point of the distribution optical cable and the branch optical cable and provide sealing protection for the branch point; and

a connector unit, configured to terminate the branch optical cable.

For example, the distribution optical cable needs to branch off at 3 user access points according to a deployment plan, and the numbers of fibers to branch off to the 3 user access points are 4, 8, and 6, respectively. Therefore, such a prefabricated distribution optical cable may be made in the factory: 3 (or more) optical cable subunits are wrapped in the distribution optical cable, and the numbers of fibers in the 3 optical cable subunits are 4, 8, and 6, respectively. The corresponding optical cable subunit branches off at the planned branch point, and other optical cable subunits in the distribution optical cable remain straight-through. Afterward, the branch point is fastened and sealing protection is provided by using a branch protecting unit, and the branch optical cable is terminated by using a connector unit. Therefore, the branch optical cable subunit is independent of the straight-through optical cable subunit, thereby avoiding damage to the straight-through fibers in the process of prefabricating the branch fibers in the factory.

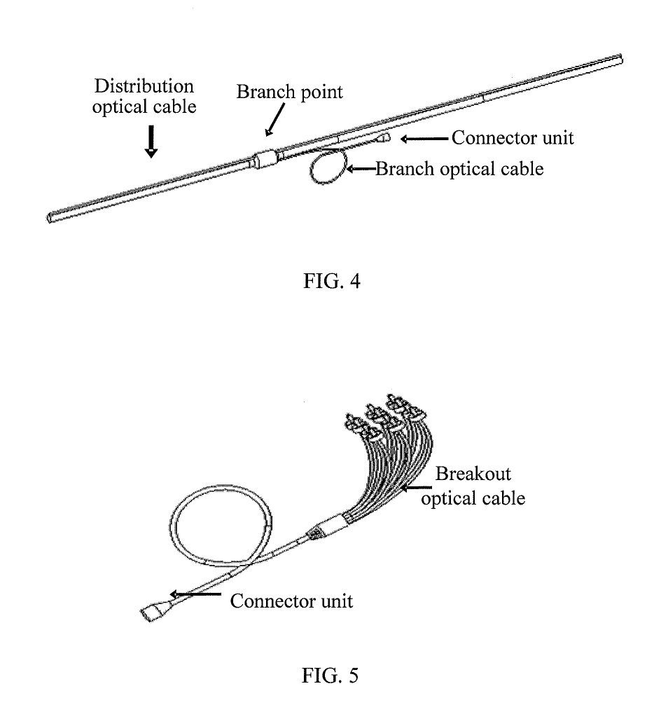

The branch protecting unit is flexible and pressure-resistant. Specifically, as shown in FIG. 3 and FIG. 4, the branch protecting unit may include:

a branching unit, connected at a branch point where the branch optical cable branches off from the distribution optical cable, in an encircling manner, and configured to fasten the branch point; and

a sealing unit, wrapped on the branching unit to provide sealing protection for the branch point. Specifically, the sealing unit may be a heat shrink tubing or cold shrink tubing.

The connector unit for terminating the branch optical cable may be a single-pin or multi-pin connector. The number of pins of the connector is equal to the number of fibers in the branch optical cable.

As shown in FIG. 5, the prefabricated distribution optical cable in this embodiment may further include a breakout optical cable. One end of the breakout optical cable is prefabricated into a single-pin or multi-pin receptacle that matches the connector unit, thereby facilitating connection with the terminated optical cable subunit. The other end of the breakout optical cable is prefabricated into a single-pin connector that is easily connectable with the drop cable.

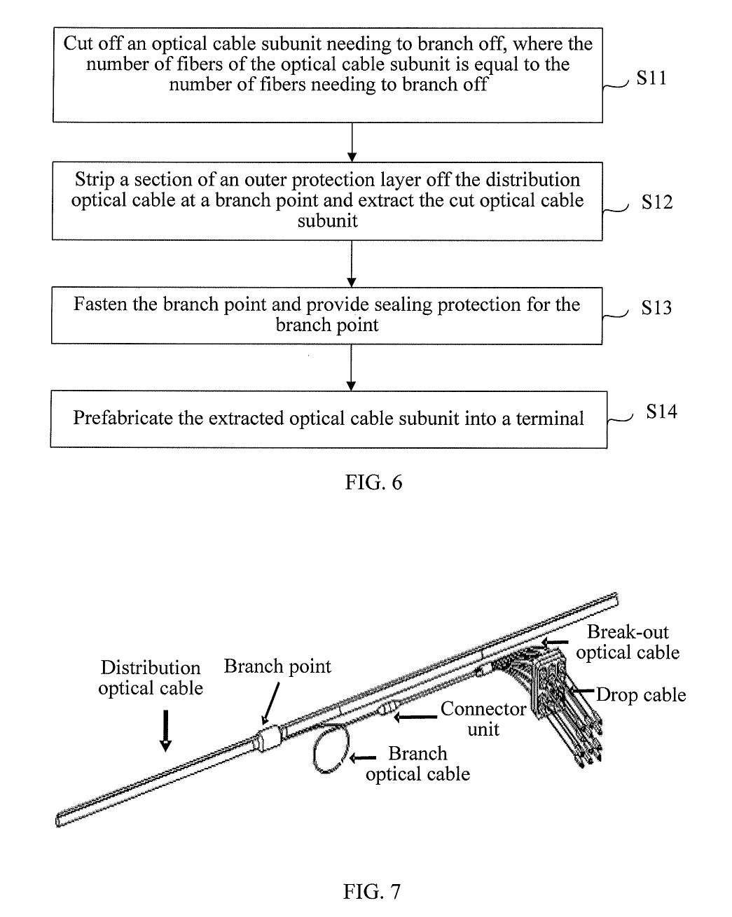

FIG. 6 is a schematic flowchart of a method for fabricating the foregoing prefabricated distribution optical cable. A method for fabricating a prefabricated distribution optical cable according to an embodiment includes the following steps.

S11. Cut off an optical cable subunit needing to branch off, where the number of fibers in the optical cable subunit is equal to the number of fibers needing to branch off.

S12. Strip a section of an outer protection layer off the distribution optical cable at a branch point and extract the cut optical cable subunit.

S13. Fasten the branch point and provide sealing protection for the branch point.

S14. Terminate the extracted optical cable subunit.

Before fabricating the prefabricated distribution optical cable, it is necessary to determine the branch points of the optical cable and the number of fibers needing to branch off at each branch point. When prefabricating the distribution optical cable, for ease of stripping off a specific length of outer protection layer of the optical cable subunit, cut off the optical cable subunit needing to branch off at a specific distance before each branch point according to the survey performed before the construction begins, where the branch points are distributed along the length of the distribution optical cable, and the distance depends on the length of the optical cable subunit needing to strip at each branch point; cut the distribution optical cable at the branch point in an encircling manner, strip a section of outer protection layer off the distribution optical cable, extract the cut optical cable subunit, fasten the branch point and provide sealing protection for the branch point, and prefabricate the extracted optical cable subunit into a terminal.

Specifically, as shown in FIG. 3 and FIG. 4, the branching unit is connected in an encircling manner at the branch point to fasten the branch point; the branching unit is wrapped with a sealing unit, where the sealing unit may be a heat shrink tubing or a cold shrink tubing for providing sealing protection for the branch point. Afterward, the extracted optical cable subunit is prefabricated into a single-pin connector or multi-pin connector. The number of pins of the connector is equal to the number of fibers in the optical cable subunit.

Because the optical cable subunits in the distribution optical cable are independent of each other, only the corresponding optical cable subunit needs to be extracted when branching, which prevents impact on other optical cable subunits in the same distribution optical cable, thereby avoiding damage to the straight-through fibers in other optical cable subunits in the process of prefabricating the branch fibers in the factory. Besides, the branch point of the optical cable is protected by both the branching unit and the sealing unit, thereby further avoiding damage to other optical cable subunits in the process of prefabricating the branch fibers in the factory. Moreover, the branch protection structure is easy to operate.

Further, the method for fabricating a prefabricated distribution optical cable provided by this embodiment may further include:

connecting the terminated optical cable subunit with a breakout optical cable.

One end of the breakout optical cable may be prefabricated into a single-pin or multi-pin receptacle that matches the terminated optical cable subunit, thereby facilitating connection with the terminated optical cable subunit. The other end of the breakout optical cable is prefabricated into a single-pin connector that is easily connectable with the drop cable.

FIG. 7 is an application scenario of connecting a prefabricated distribution optical cable with a drop cable. At the user access point, the breakout optical cable is connected to a respective user terminal through a single-fiber drop cable.

Through the breakout optical cable, the branch optical cable can be connected to the drop cable conveniently, thereby connecting the fibers into the user's premises quickly. Moreover, in the method for fabricating the prefabricated distribution optical cable in the present invention, the optical cable does not need to be spliced in the process of prefabricating the branch fibers in the factory, thereby reducing link attenuation, cutting back costs, and facilitating subsequent maintenance and expansion.

The above descriptions are merely exemplary embodiments and are not intended to limit the protection scope of the claims. Other variations or replacement to these embodiments that can be derived by persons skilled in the art are understood to fall within the protection scope of the claims.

What is claimed is:

1. A prefabricated distribution optical cable, comprising:
a distribution optical cable that includes at least one optical cable subunit, wherein a number of fibers of each optical cable subunit is equal to a number of fibers required to branch off;
a branch optical cable being an optical cable subunit of a specific length branching off from the distribution optical cable;
a branch protecting unit configured to fasten a branch point of the distribution optical cable and the branch optical cable and provide a seal for the branch point; and
a connector unit configured to terminate the branch optical cable, wherein a number of fibers of the terminated cable is equal to a number of fibers in the branch optical cable.

2. The prefabricated distribution optical cable according to claim 1, wherein the branch protecting unit comprises:
a branching unit connected at a branch point where the branch optical cable branches off from the distribution optical cable in an encircling manner, wherein the branching unit is configured to fasten the branch point; and
a sealing unit configured to wrap the branching unit to provide a seal for the branch point.

3. The prefabricated distribution optical cable according to claim 1, wherein the connector unit is a single-pin or multi-pin connector, and a number of pins of the connector is equal to the number of fibers in the branch optical cable.

4. The prefabricated distribution optical cable according to claim 1, further comprising:
a breakout optical cable, wherein one end of the breakout optical cable is connected with the terminated branch optical cable through a matched connector unit, and the other end is prefabricated into a terminal for connecting with a drop cable.

5. A method for fabricating a prefabricated distribution optical cable, comprising:
cutting off an optical cable subunit required to branch off, wherein a number of fibers of the optical cable subunit is equal to a number of fibers required to branch off;
stripping off a section of an outer protection layer from the distribution optical cable at a branch point;
extracting the cut optical cable subunit;
fastening the branch point and providing a seal for the branch point; and
terminating the extracted optical cable subunit, wherein a number of fibers of the terminated cable is equal to a number of fibers in the extracted optical cable subunit.

6. The method for fabricating a prefabricated distribution optical cable according to claim 5, wherein fastening of the branch point and providing of the seal for the branch point comprises:
connecting a branching unit at the branch point to fasten the branch point in an encircling manner; and
wrapping the branching unit with a sealing unit to provide the seal for the branch point.

7. The method for fabricating a prefabricated distribution optical cable according to claim 5, wherein terminating of the extracted optical cable subunit comprises:
prefabricating the extracted optical cable subunit into a single-pin connector or a multi-pin connector, wherein a number of pins of the connector is equal to a number of fibers in the optical cable subunit.

8. The method for fabricating a prefabricated distribution optical cable according to claim 5, further comprising:
connecting one end of a breakout optical cable with the terminated optical cable subunit through a matched connector unit; and
prefabricating an opposite end of the breakout optical cable into a terminal for connecting with a drop cable.

9. A prefabricated distribution optical cable, comprising:
a distribution optical cable that includes a plurality of optical cable subunits, wherein a number of fibers of each optical cable subunit is equal to a number of fibers required to branch off, and wherein one of the optical cable subunits branches from the distribution optical cable to be a branch optical cable;
a connector unit configured to terminate the branch optical cable, wherein a number of fibers of the terminated cable is equal to a number of fibers in the branch optical cable.

10. The prefabricated distribution optical cable according to claim 9, further comprising:
a branch protecting unit configured to fasten a branch point of the distribution optical cable and the branch optical cable and to provide a seal for the branch point.

11. The prefabricated distribution optical cable according to claim 10, wherein the branch protecting unit comprises:
a branching unit connected at a branch point of the distribution optical cable, where the branch optical cable branches off from the distribution optical cable in an encircling manner, and is configured to fasten the branch point of the distribution optical cable.

12. The prefabricated distribution optical cable according to claim 10, wherein the branch protecting unit further comprises:
a sealing unit configured to wrap the branching unit to provide a seal for the branch point.

13. The prefabricated distribution optical cable according to claim 9, wherein the connector unit is a single-pin or a multi-pin connector, and a number of pins of the connector is equal to the number of fibers in the branch optical cable.

14. The prefabricated distribution optical cable according to claim 9, further comprising:
a breakout optical cable, wherein one end of the breakout optical cable is prefabricated into a single-pin or a multi-pin receptacle that matches the connector unit, and an opposite end of the breakout optical cable is prefabricated into a single-pin connector for connecting with a drop cable.

15. The prefabricated distribution optical cable according to claim 9, wherein the plurality of optical cable subunits comprise a first optical cable subunit, a second optical cable subunit, and a third optical cable subunit, wherein a numbers of fibers of the first optical cable subunit and the second optical cable subunit and the third optical cable subunit are different.

16. The prefabricated distribution optical cable according to claim 15, wherein the first optical cable subunit branches from a first branch point, while the second optical cable subunit and the third optical cable remain straight-through in the distribution optical cable.

17. The prefabricated distribution optical cable according to claim 16, wherein the second optical cable subunit branches from a second branch point different from the first branch point, while the third optical cable remains straight-through in the distribution optical cable.
